(19) United States
(12) Patent Application Publication
(10) Pub. No.: US 2009/0254458 A1
(43) Pub. Date: Oct. 8, 2009

(54) System and Method for Creating a Shared Electronic Shopping Environment

(76) Inventor: Clement Gerard Day, Ashby-de-la-Zouch (GB)

Correspondence Address: The Marbury Law Group, PLLC, 11800 SUNRISE VALLEY DRIVE, SUITE 1000, RESTON, VA, 20191, US

(21) Appl. No.: 12/420,100

(22) Filed: Apr. 8, 2009

Related U.S. Application Data
(60) Provisional application No. 61/043,250, filed on Apr. 8, 2008.

(51) Int. Cl. G06Q 30/00; G06Q 10/00; G06Q 50/00

(52) U.S. Cl. 705/27; 705/28; 705/26

(57) ABSTRACT

A shared shopping environment comprises common inventory that serves one or more web stores. The web stores share a common domain and sell items identified in the common inventory. Each web-based store may provide information about the items offered for sale at that store site. The information offered by the web-based stores is available to a shopper through a common search engine. A shopper may purchase items from any of the stores using a single shopping cart. Orders for each of the stores are fulfilled from the common inventory.

### CROSS-REFERENCE TO RELATED APPLICATIONS

This application claims the benefit of Provisional Application No. 61/043,250 filed Apr. 8, 2008. The 61/043,250 application is incorporated by reference herein, in its entirety, for all purposes.

### BACKGROUND

The sale and distribution of goods from virtual stores over the Internet have changed to the way people shop for the things they need and want. Internet shopping generates significant revenue streams for virtual retailers world-wide.

However, smaller retailers are often faced with pricing advantages afforded to large vendors that smaller retailers cannot receive. Even when price is not a motivating factor in determining where a potential buyer may acquire an item, the smaller retailer may not be noticed among the large retailers with significant advertising resources.

Niche online stores (also referred to as niche retailers) offer a wealth of specialist information and expertise which creates a highly desirable shopping experience for their customers. This expertise distinguishes such niche retailers from the mass market e-commerce giants which can easily undercut the niche retailer on price but which does not offer the same expertise as the niche retailer across their entire product range. The “niche scaling” problem has been typically tackled in one of three ways:

Data mining: creating custom product groupings by analyzing sales data. This yields the result “Customers who bought x also bought y.”

While this is a very cheap way to recreate the niche relationships between products, the weakness of this approach is that its reveals nothing about the relationship between products the customer already owns (which have been purchased elsewhere). Additionally, the results are easily muddied by people buying products as gifts.

Customer reviews: allowing customers to write reviews of products and add the reviews to a database.

This is an easy way on a product level basis to tap into some of the expert knowledge that their customer base may have. While this provides some assistance to people making their purchasing decisions, the reviews are product specific and do nothing to relate or group products. For example, a customer might write a review of the track “My Name Is” by Eminem. The review may mention that this track contains a sample from Labi Siffre's song, “I Got The,” and may even go as far as to say that the group ‘Chaz and Dave’ were session players on this recording. However, the presence of the review does not alone create pages that directly group these products together.

Affiliate programs: With an affiliate program, a niche retailer can further tap into the expert knowledge of users by offering users the ability to write about products and post links to products in exchange for a small sales commission.

Again, using a music product as, an example, a user who writes a blog about Eminem can thus create a page on a website presenting reviews and links to Eminem content along with the sample tracks while optionally providing links to some of the other artists on Eminem's own record label. Such a solution produces valuable groupings and relationships between products. However, the relationships are only accessible on the affiliate's site. That is, the links only go from the affiliate to the store—the store does not link back. What this means is that if a customer were to arrive directly at the online store, the customer would have no way of accessing any of the valuable information created by the store's network of affiliates. Furthermore, the content generated on one affiliate's site is not accessible via any other affiliates. The content generated exists in isolation.

### SUMMARY

Various embodiments provide methods and systems for creating a shopping environment that allows goods and information about those goods to be related in a common venue and which allows customers to conveniently shop in the various venues for items of interest.

### DESCRIPTION OF THE DRAWINGS

The accompanying drawings, which are incorporated herein and constitute part of this specification, illustrate exemplary aspects of the invention. Together with the general description given above and the detailed description given below, the drawings serve to explain features of the invention.

FIG. 1 is a block diagram illustrating a web-based retail store domain according to an embodiment hereof.

FIG. 2 is a process flow diagram illustrating a flow of a purchasing process to an embodiment.

FIG. 3 is a block diagram illustrating functional components of a personal computer.

FIG. 4 is a block diagram illustrating functional components of a wireless device.

FIG. 5 is a block diagram illustrating functional components of a server.

### DETAILED DESCRIPTION

In the detailed description that follows, various embodiments are described in which electronic music files are offered for sale. However, this is not meant to be a limitation. Other electronic “content files,” including without limitation, electronic video files, electronic image files, electronic book files, electronic map files, and the like may be offered for sale using the same described methods and structures without departing from the scope hereof. Additionally, the methods and structures described below may be used for goods of any kind. To avoid any confusion as to whether electronic files are “goods,” electronic files and goods are collectively referred to as “items.”

Various aspects will be described in detail with reference to the accompanying drawings. References made to particular examples and implementations are for illustrative purposes and are not intended to limit the scope of the invention or the claims.

As used herein, the term “computing device” encompasses, for example, desktop computers, laptop computers and mobile devices and-other processor-equipped devices that may be developed in the future that may be configured to permit a user to interact other devices over a network. As used herein, “mobile device” encompasses cellular telephones, personal data assistants (PDA), and smart telephones.

As used herein, the terms “store,” “storefront,” and “web store” are used to describe websites that offer items for sale.

As used herein, the term “warehouse” encompasses a physical location from which orders of items may be fulfilled, a collection of such physical locations, or a database or catalogue of items that may be obtained from any source to fulfill an order.

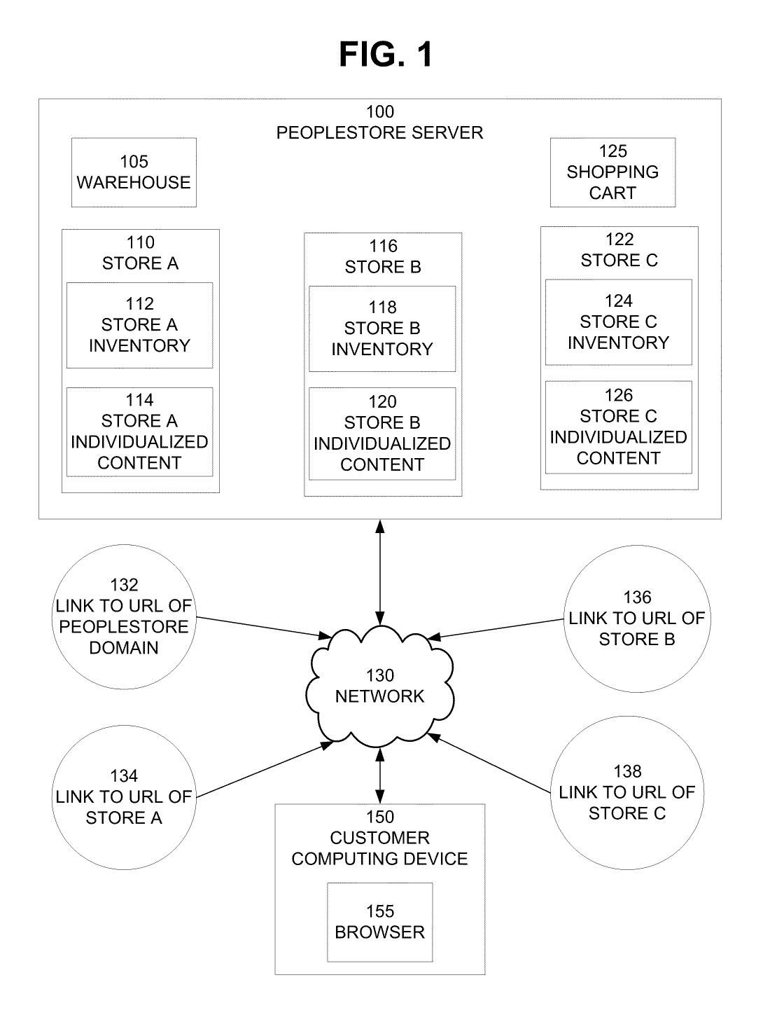

FIG. 1 is a block diagram illustrating a web-based retail environment domain according to an embodiment. As illustrated, the web-based-retail environment is associated with a domain name having a subdomain, for example, “peoplestore” and a top level domain, for example, “eu.” Using these exemplary elements, the domain name associated with peoplestore server 100 is “peoplestore.eu” and the domain of the site is referred to as the “peoplestore” domain.

A peoplestore server 100 comprises a store A 110, a store B 116, and a store C 122. While only three stores are illustrated, this is not meant as a limitation. The peoplestore server 100 further comprises a warehouse 105 and a shopping cart 125. In an embodiment, the stores A, B and C (110, 116, and 122 respectively), the warehouse 105 and the shopping cart 125 are implemented by one or more applications stored in a memory of the peoplestore server 100 and executed in a processor of the peoplestore server 100. As will be appreciated by those of ordinary skill, the illustrated elements of the peoplestore server 100 may be distributed across multiple physical devices and implemented using multiple applications.

In an embodiment, the store 110 is assigned a universal resource locator (URL) within the peoplestore domain in the form of “www.peoplestore.com/store110.” Similarly, the store 116 is assigned a URL in the form of “www.peoplestore.eu/store116” and the store 122 is assigned a URL in the form of “www.peoplestore.eu/store122.” However, this is not meant as a limitation. For example, store 110 could be assigned a subdomain in the form of “110store.peoplestore.eu” with the peoplestore domain. In this way, any number of distinct webstores may be created within the domain of the peoplestore server 100.

Each store within the peoplestore server 100 is permitted to link to items identified in the warehouse 105. In an embodiment, a store is limited to a preset number of items that may be sold. It is anticipated that numerous storefronts will be created. The warehouse 105 does-not directly offer items for sale. Rather, a search request made from the root domain produces a list of stores within the peoplestore domain offering the desired product or item.

In an embodiment, a store owner creates a store presence within the domain of peoplestore server 100. By way of illustration and not as a limitation, a store owner may access peoplestore server 100 to select items to be sold on the store owner's webstore from the common inventory held in warehouse 105. The store owner may also upload individualized content for review on the store owner's webstore so as to differentiate the store owner's webstore from the other webstores under the domain of people server 100. A potential purchaser will have the opportunity to review some or all of the content posted by the various store owners. Because various store owners sell the same items, the individualized content may provide the basis for a potential purchaser to select one store over another. This embodiment is illustrated in FIG. 1. Store 110 comprises a store A inventory 112 and store A individualized content 114. Similarly, store 116 comprises a store B inventory 118 and store B individualized content 120, and store 122 comprises a store C inventory 124 and store C individualized content 126.

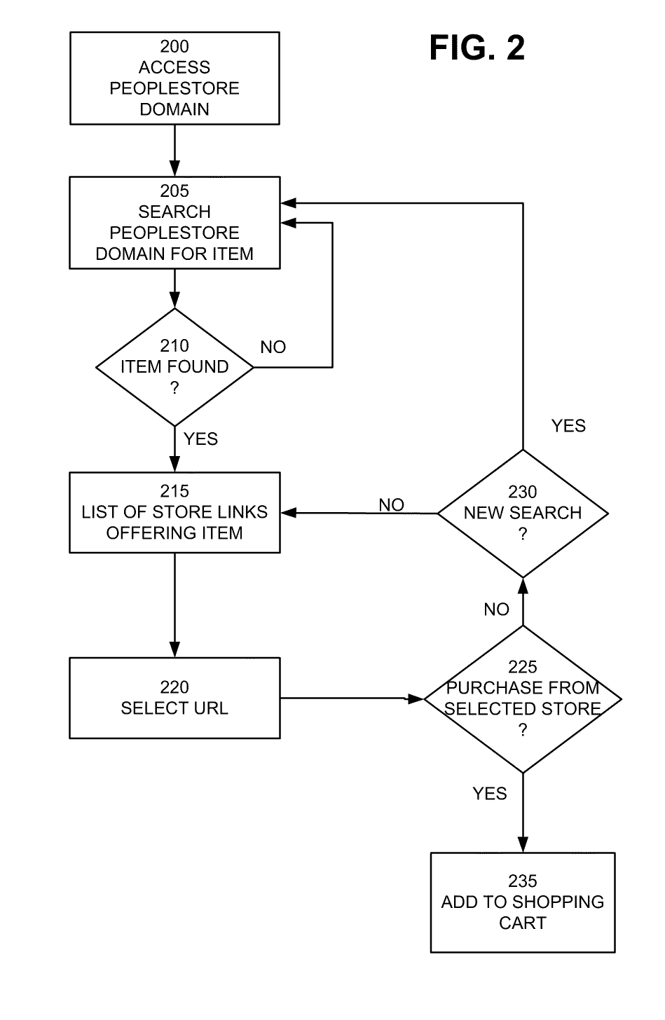

FIG. 2 is a flow diagram illustrating a purchasing behavior according to an embodiment. Referring to FIG. 1 and FIG. 2, by way of illustration and not as a limitation, the warehouse 105 comprises music content files. A user accesses the peoplestore domain, block 200. The user uses a search engine on the peoplestore domain to search for item within the peoplestore domain, block 205. If item is not available for sale on the peoplestore domain (i.e., decision 210 is “No”), the process returns to the search function, block 205.

If the item is available on the peoplestore domain (i.e., decision 215 is “Yes”), the user is provided a list of links to-the stores-offering the item, block 215, such as the stores A, B and C (110, 116, and 122 respectively). The user may select a link of anyone one of the listed stores, block 220. The user may elect to purchase the item from the selected store (i.e., decision 225 is “Yes”) and the item will be added to a shopping cart, block 235. When the user elects not to purchase the item from the selected store (i.e., decision 225 is “No”) the user may return to the list of store links (i.e., the decision 230 is “No”) or the user may elect to conduct a new search (i.e., the decision 230 is “Yes”). In this way, a user may review the individualized content posted by all of the stores selling a particular item before deciding to purchase the item and before deciding from which store the item will be purchased.

The shopping cart 125 (referred to in block 235) may be used to acquire items from any of the stores identified in the list of links to the stores offering the item, block 215.

In an embodiment, the items stored in the warehouse 105 comprise licensed digital content. By way of illustration and not as a limitation, the content files comprise music files, video files, image files, book files, map files among others. However, this is not meant as a limitation. In another embodiment, the warehouse 105 comprises a database or catalog of items that may be purchased and shipped from one or more physical warehouses (not illustrated). For example, the warehouse 105 may comprise a catalog of digital content that is stored on physical media, a catalog of electronic devices, a catalog of books, a catalog of art, and so on.

In an embodiment, the warehouse 105 supplies the graphical representation of items for display on the storefront. The peoplestore server 100 also provides a shopping cart 125. The shopping cart 125 receives purchase selections from all the stores 110, 116, and 122. Thus, a purchaser is able to browse from store to store adding items to a single shopping cart, to pay at a single checkout and to obtain fulfillment from one or more locations that are controlled by the operator of the warehouse. In this way, the sale is made by the various store owners at their respective storefronts while fulfillment-is performed by the operator of the content file the warehouse 105.

While the operator of the peoplestore domain controls the content and the fulfillment of orders of items, as previously described, a store owner creates a context for the items that are presented on the store owner's storefront. The context allows a store owner to differentiate his or her storefront from other storefronts selling the same items. It is up to the store owner to market the items using whatever means they select. By way of example, the store owner may also upload individualized content for review on the store owner's webstore. The individualized content may encompass text, video, audio and combinations of the same.

FIG. 1 illustrates a link to the URL of peoplestore domain 132, a link to the URL of store A 134, a link to the URL of store B 136, and a link to the URL of store C 138. It is anticipated that store owners will reference the URL of the peoplestore server 100 and at least their own store as part of such a marketing effort.

In an embodiment, the store owner earns rewards through sales generated by the sales of items from the storefront. In an embodiment, the rewards are in the form of tokens which can be redeemed to buy items. However, this is not meant as a limitation. Rewards may be in the form of cash payments, electronic funds, or other forms of consideration.

The customer computing device 150 comprises a browser 155 that permits a user of the customer computing device 150 to access a web page served by the peoplestore server 100 and to search the domain for items to purchase using a common search engine. A search request made from the root domain produces a list of stores within the peoplestore domain that offer the desired item. The store list comprises links to each of the stores 110, 116, and 122 that offer the searched product for sale. The user of customer computing device 150 can then browse each of the stores offering the desired item and obtain information about the desired content and related content. The user may elect to purchase the desired item and any related items of interest to the user.

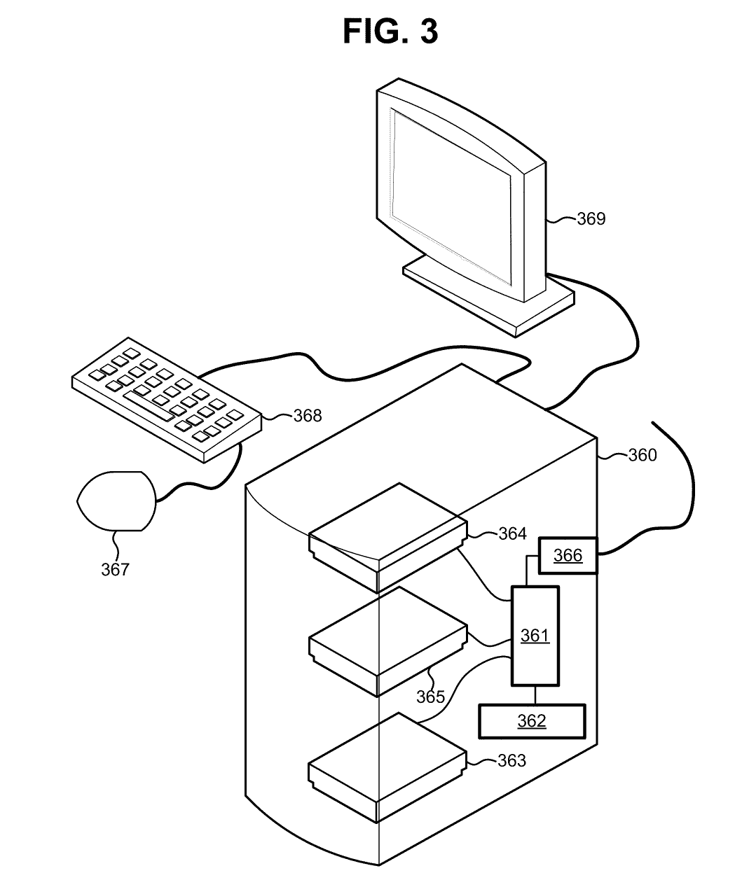

As previously described, a user may interact with the peoplestore server using a variety of the computing devices, including a personal computer. By way of illustration, the functionality of the customer computing device 150 may be implemented on a personal computer 360 illustrated in FIG. 3. Such a personal computer 360 typically includes a processor 361 coupled to volatile memory 362 and a large capacity nonvolatile memory, such as a disk drive 363. The computer 360 may also include a floppy disc drive 364 and a compact disc (CD) drive 365 coupled to the processor 361. Typically the computer device 360 will also include a pointing device such as a mouse 367, a user input device such as a keyboard 368 and a display 369. The computer device 360 may also include a number of connector ports coupled to the processor 361 for establishing data connections or receiving external memory devices, such as a USB or FireWire® connector sockets or other network connection circuits 366 for coupling the processor 361 to a network. In a notebook configuration, the computer housing includes the pointing device 367, keyboard 368 and the display 369 as is well known in the computer arts.

While the capability of the definition exchange system 100 has been disclosed with respect to a customer computing device 150 (see, FIG. 1), those skilled in the art will also appreciate that the system can be embodied in a manner that is useful to mobile devices. For example, cell phones, PDA's and other mobile devices may all perform the functions of customer computing device 150.

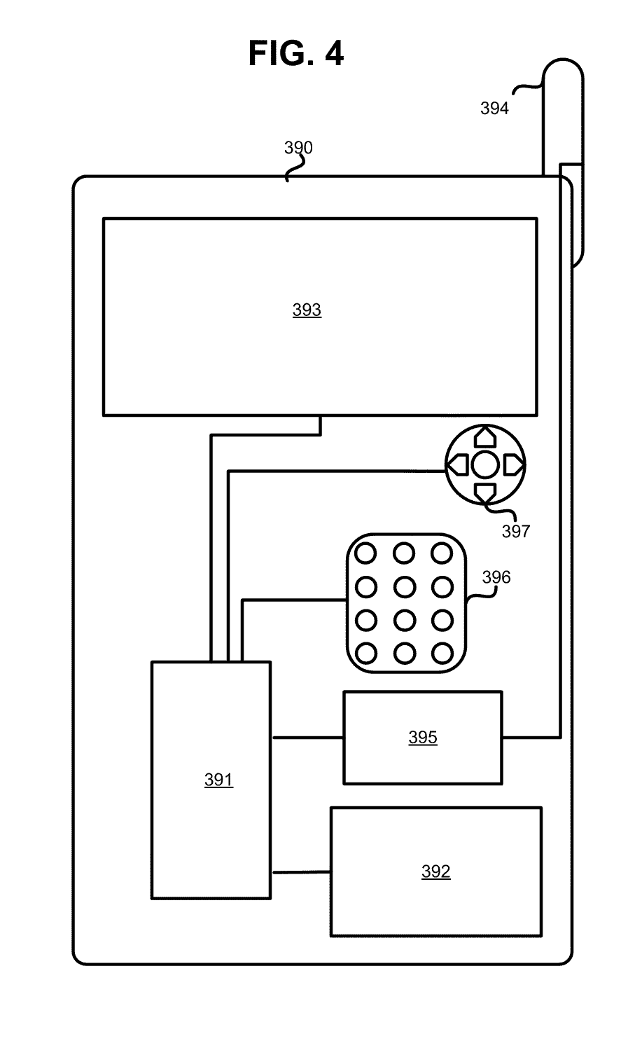

Typical mobile devices suitable for use with the various embodiments will have in common the components illustrated in FIG. 4. For example, the exemplary mobile device 390 may include a processor 391 coupled to internal memory 392, a display 393 and to a SIM 399 or similar removable memory unit. Additionally, the mobile device 390 may have an antenna 394 for sending and receiving electro magnetic radiation that is connected to a wireless data link and/or cellular telephone transceiver 395 coupled to the processor 391. In some implementations, the transceiver 395 and portions of the processor 391 and memory 392 used for cellular telephone communications are collectively referred to as the air interface since it provides a data interface via a wireless data link. Mobile devices typically also include a key pad 396 or miniature keyboard and menu selection buttons or rocker switches 397 for receiving user inputs.

The processor 391 may be any programmable microprocessor, microcomputer or multiple processor chip or chips that can be configured by software instructions (applications) to perform a variety of functions, including the functions of the various embodiments described herein. In some mobile devices, multiple processors 391 may be provided, such as one processor dedicated to wireless communication functions and one processor dedicated to running other applications. Typically, software applications may be stored in the internal memory 392 before they are accessed and loaded into the processor 391. In some mobile devices, the processor 391 may include internal memory sufficient to store the application software instructions. The internal memory of the processor may include a secure memory 398 which is not directly accessible by users or applications and that is capable of recording MDINs and SIM IDs as described in the various embodiments. As part of the processor, such a secure memory 398 may not be replaced or accessed without damaging or replacing the processor. In some mobile devices, additional memory chips. (e.g., a Secure Data (SD) card) may be plugged into the device 390 and coupled to the processor 391. In many mobile devices, the internal memory 392 may be a volatile or nonvolatile memory, such as flash memory, or a mixture of both. For the purposes of this description, a general reference to memory refers to all memory accessible by the processor 391, including internal memory 392, removable memory plugged into the mobile device, and memory within the processor 391 itself, including the secure memory 398.

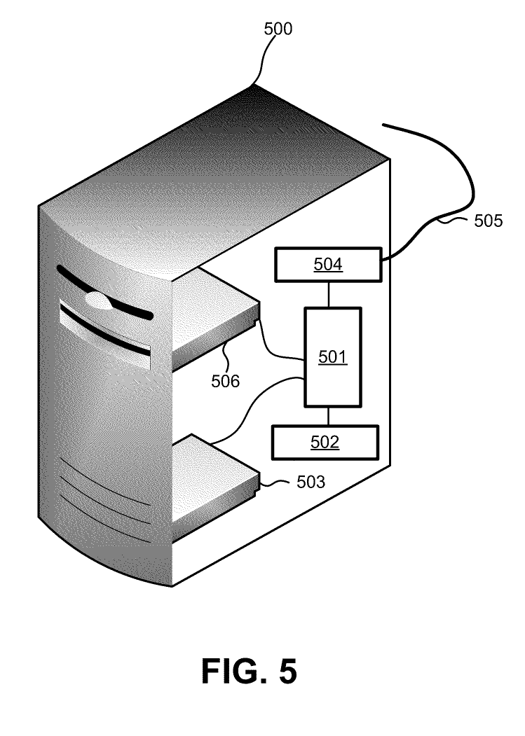

A number of the aspects described above may also be implemented with any of a variety of remote server devices, such as the server 500 illustrated in FIG. 5. Such a server 500 typically includes a processor 501 coupled to volatile memory 502 and a large capacity nonvolatile memory, such as a disk drive 503. The server 500 may also include a floppy disk drive and/or a compact disc (CD) drive 506 coupled to the processor 501. The server 500 may also include a number of connector ports 504 coupled to the processor 501 for establishing data connections with network circuits 505.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Further, words such as “thereafter,” “then,” “next,” etc. are not intended to limit the order of the steps; these words are simply used to guide the reader through the description of the methods.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of the computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disc storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as bused herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the principles and novel features disclosed herein. Further, any reference to claim elements in the singular, for example, using the articles “a,” “an,” or “the,” is not to be construed as limiting the element to the singular.

What is claimed is:

1. A system for sharing a common inventory among a plurality of web stores comprising:
a common inventory database, wherein the common inventory database comprises a common catalogue of items for sale;
a server comprising a memory and a processor, wherein the memory comprises software executable instructions, wherein the processor is coupled to the memory, and wherein the processor is configured with the software executable instructions to perform operations comprising:
associating an inventory of items with each of the plurality of web stores wherein each inventory comprises items selected from the common inventory database;
generating a store web page for each web store, wherein the web store page for a particular web store comprises an index of the inventory of items associated with that web store;
receiving requests for selected web store pages from a customer computing device;
serving the selected store web pages to the customer computing device;
receiving from the customer computing device an offer to purchase an item, wherein the item is identified on at least two of the indices associated with the selected store web pages; and
fulfilling the offer to purchase the item from any one of the selected web stores from the common inventory database.

2. The system of claim 1, wherein the items for sale comprise electronic content files selected from the group consisting of music files, video files, image files, book files, and map files.

3. The system of claim 1, wherein the items for sale comprise physical goods selected from the group consisting of digital content that is stored on physical media, electronic devices, books, and art.

4. The system of claim 1, wherein the customer computing device is selected from the group consisting of a desktop computer, a laptop computer and a mobile device.

5. The system of claim 4, wherein the mobile device is selected from the group consisting of cellular telephones, personal data assistants (PDA), and smart telephones.

6. The system of claim 1, wherein the web store page for the particular web store further comprises information received from an owner of the particular web store about at least one item identified in the index of the inventory of items associated with that web store.

7. The system of claim 1, wherein the server is associated with a domain and wherein each of the plurality of web stores is assigned a universal resource locator within the server domain.

8. A method for sharing a common inventory of items among a plurality of web stores comprising:
associating an inventory of items with each of the plurality of web stores, wherein each inventory comprises items selected from the common inventory;
generating a store web page for each web store, wherein the web store page for a particular web store comprises an index of the inventory of items associated with that web store;
receiving requests for selected web store pages from a customer computing device;
serving the selected store web pages to-the customer computing device;
receiving from the customer computing device-an offer to purchase an item, wherein the item is identified on at least two of the indices associated with the selected store web pages; and
fulfilling the offer to purchase the item from any one of the selected web stores from the common inventory database.

9. The method of claim 8, wherein the items for sale comprise electronic content files selected from the group consisting of music files, video files, image files, book files, and map files.

10. The method of claim 8, wherein the items for sale comprise physical goods selected from the group consisting of digital content that is stored on physical media, electronic devices, books, and art.

11. The method of claim 8, wherein the customer computing device is selected from the group consisting of a desktop computer, a laptop-computer and a mobile device.

12. The method of claim 11, wherein the mobile device is selected from the group consisting of cellular telephones, personal data assistants (PDA), and smart telephones.

13. The method of claim 8, wherein the web store page for the particular web store further comprises information received from an owner of the particular web store about at least one item identified in the index of the inventory of items associated with that web store.

14. The method of claim 8 further comprising:
associating the server with a domain; and,
assigning each of the plurality of web stores a universal resource locator within the server domain.
